(19) United States
(12) Patent Application Publication
(10) Pub. No.: US 2022/0131409 A1
(43) Pub. Date: Apr. 28, 2022

(54) DUAL POWER SWITCHING SYSTEM

(71) Applicant: Kanghong Zhang, Santa Fe Springs, CA (US)

(72) Inventor: Kanghong Zhang, Santa Fe Springs, CA (US)

(21) Appl. No.: 17/082,540

(22) Filed: Oct. 28, 2020

(51) Int. Cl. H02J 9/06

(52) U.S. Cl. CPC H02J 9/065

(57) ABSTRACT

A dual power switching system has a power input and a normal driver. The power input is connected to the normal driver and powers the normal driver. A logic circuit is configured to detect an abnormal power state. A secondary driver is connected to the logic circuit. The logic circuit activates the secondary driver in the abnormal power state. A series of lamps is powered by the normal driver in a normal state, and powered by the secondary driver in the abnormal power state. The lamps can be connected to the normal driver and also the secondary driver. The emergency power supply includes a secondary emergency switch and a boost power supply.

### FIELD OF THE INVENTION

The present invention is in the field of a dual power switching system.

### DISCUSSION OF RELATED ART

A variety of different United States patents have provided retrofit emergency lighting systems, but these are designed as complete systems rather than retrofits.

For example, in the U.S. Pat. No. 3,906,243 Herzog, Retrofit Emergency Lighting System by inventor Rolley R. Herzog, published Sep. 16, 1975 the abstract discloses, “A retrofit emergency lighting system including a 60 Hz AC ballast for operating at least one gaseous discharge lamp. There is provided a means for substantially electrically isolating the secondary side of the ballast transformer from ground thereby reducing the hazard of electrical shock during lamp replacement. The ballast transformer is an isolation transformer having the secondary winding connected across the lamp. A pair of filament windings are connected to the filaments of the lamp and are positioned laterally with respect to the primary winding and in a pancake form so as to provide low capacitance between the filament windings and primary winding. An inverter circuit, which is driven by a DC battery, is further connected across the lamp for operating the lamp during emergency conditions. The inverter circuit operates at such a frequency so as to minimize capacitive leakage and inductive shunt current losses.”

For example, in the U.S. Pat. No. 4,144,462, Emergency Light Battery Charger Circuit by inventor Thomas F. Roche, published Apr. 17, 1979 the abstract discloses, “A battery charger circuit for providing a charging current to a rechargeable battery from AC line voltage. The charger circuit is especially adapted for use in an emergency light and includes circuitry to provide automatic charging current shut-off when the battery is fully charged. Failure of AC power is detected by the charger circuit, and current is applied to an emergency lamp in response to such failure. Circuitry is included for monitoring the charge state of the battery and for interrupting discharge current to the lamp from the battery when the charge state falls below a predetermined limit. Provision is included for use of the battery charger circuit in a portable lantern configuration.”

For example, in the U.S. Pat. No. 4,216,410, Emergency Lighting System by inventor Robert S. Feldstein, published Aug. 5, 1980 the abstract discloses, “An emergency light entirely self-contained that fits into a standard AC fixture in place of a fluorescent or other vapor lamp employs a similar lamp and a rechargeable battery with a system which operates the lamp normally on AC but if AC power fails operates the lamp using battery power. During normal operation on AC the battery is charged by a rectifier charger unit operating in series with the lamp current, which limits battery charge current. When AC power fails the lamp is electrically isolated from the AC line and operated by an inverter unit drawing power from the battery.”For example, in the U.S. Pat. No. 4,223,232, Battery Charging Circuit For

An Emergency System by inventor Bulent Bulat, published Sep. 16, 1980 the abstract discloses, “A single active element performs the multiple functions of regulating DC voltage level from an AC source supplied to charge a battery and of coupling the battery to power an emergency system such as an emergency lighting system upon loss of the AC source. Preferably, the single active element also performs a third function of disconnecting the battery from the emergency system in time to prevent over discharge and consequent permanent damage to the battery.”

For example, in the U.S. Pat. No. 5,365,145, Emergency Lighting System by inventor Gregory S. Fields, published Nov. 15, 1994 the abstract discloses, “An emergency lighting system for providing low voltage DC battery powered illumination to one or more areas of a home, apartment, office or other building structure in an emergency mode upon the failure or termination in such areas of a normal AC power mode. The system includes a voltage step-down transformer with the leads of its primary winding interconnected to a normal AC power source and forming therewith an AC circuit. A power rectifier has its input leads interconnected to the terminals of the low AC voltage secondary winding of the transformer and its DC voltage output leads interconnected to the terminals of an emergency battery power source. One or more low voltage incandescent lamps are interconnected to the terminals of the battery and form therewith an emergency DC circuit. A control relay interacts between the AC circuit and the DC circuit of the system with the DC circuit contacts of the relay interconnected in one of the low voltage leads of the DC circuit between the lamps and the battery and with the coil of the relay interconnected in the AC circuit for maintaining the DC contacts of the DC circuit open during normal AC current flow in the AC circuit and responsive to a termination or failure of the AC power source and cessation of AC current flow in the AC circuit to close the DC circuit contacts of the relay whereby the low voltage lamps are energized by the battery to produce emergency illumination.”

For example, in the U.S. Pat. No. 5,859,499, Emergency Lighting System With A DC Sensing Load Relay by inventor Robert McAfee et al., published Jan. 12, 1999 the abstract discloses, “An emergency lighting system has emergency light units operable by DC power and connected to a source of AC and DC power by the same conduit system. Power to the conduit system may be switched from AC to DC in the event of a power failure and a load relay module in the conduit system adjacent the light units senses the change to DC current and switches from an Ac load output to a DC load output to supply DC power to the emergency light units. The system will generally include both exit signs operable by both AC and DC power and emergency light units operable only by DC power.”

### SUMMARY OF THE INVENTION

The present invention is an emergency system for multiple fixtures. Most emergency ballasts or drivers are designed for individual fixtures. The emergency ballasts drives the load such as a fluorescent or LED light emitting diode lamp directly so modularized wiring is difficult to install and maintain. The present invention differs from the prior art by providing an emergency system for one or multiple fixtures on the same circuit without extra wiring for emergency control in each individual picture. The present invention uses different voltages to distinguish normal operation or emergency operation. A driver or adapter in the fixture can respond to different voltages to work in a correct mode.

Objects of the present invention include providing benefits by allowing reuse of presently existing wiring, minimizing cost increases for driver designs, enabling any fixture to be emergency ready, and achieving a centralized single circuit emergency system.

A dual power switching system has a power input and a normal driver. The power input is connected to the normal driver and powers the normal driver. A logic circuit is configured to detect an abnormal power state. A secondary driver is connected to the logic circuit. The logic circuit activates the secondary driver in the abnormal power state. A series of lamps is powered by the normal driver in a normal state, and powered by the secondary driver in the abnormal power state. The lamps can be connected to the normal driver and also the secondary driver. The emergency power supply includes a secondary emergency switch and a boost power supply.

The emergency power supply is incorporated into the normal driver. The normal driver has a secondary emergency switch. The emergency power supply is incorporated as a DIM input into the normal driver. The DIM input receives a signal from an emergency adapter. The logic circuit is formed on the emergency adapter. The normal driver can provide an AC output, while the emergency driver provides a DC output. The normal driver can provide a normal DC output, and the emergency driver provide a emergency DC output. The emergency DC output is lower than the normal DC output.

### BRIEF DESCRIPTION OF THE DRAWINGS

FIG. 1 is a diagram of the system showing multiple light units.

FIG. 2 is a diagram showing an emergency switch configuration.

FIG. 3 is a diagram showing an emergency switch configuration.

FIG. 4 is a diagram showing an emergency switch configuration.

FIG. 5 is a diagram showing an emergency switch configuration.

FIG. 6 is a diagram showing an emergency switch configuration.

FIG. 7 is a diagram showing installation of an emergency adapter to a normal driver.

The following call out list of elements can be a useful guide in referencing the elements of the drawings.

D1 first diode

21 first lamp

22 second lamp

23 third lamp

24 fourth lamp

29 emergency adapter

30 normal driver

31 normal driver first output

32 normal driver second output

33 normal driver first input

34 normal driver second input

40 DC driver

41 DC driver first output

42 DC driver second output

43 DC first input

44 DC driver second input

50 secondary emergency switch

51 emergency switch first output

52 emergency switch second output

53 emergency switch first input

54 emergency switch second input

55 second emergency switch logic

60 primary emergency switch

61 first power input line

62 second power input line

63 first light unit

64 second light unit

65 third light unit

66 emergency voltage

67 normal voltage

68 neutral line

70 BOOST power supply

71 BOOST power supply first output

72 BOOST power supply second output

73 BOOST power supply first input

74 BOOST power supply second input

75 signal connection

### DETAILED DESCRIPTION OF THE PREFERRED EMBODIMENT

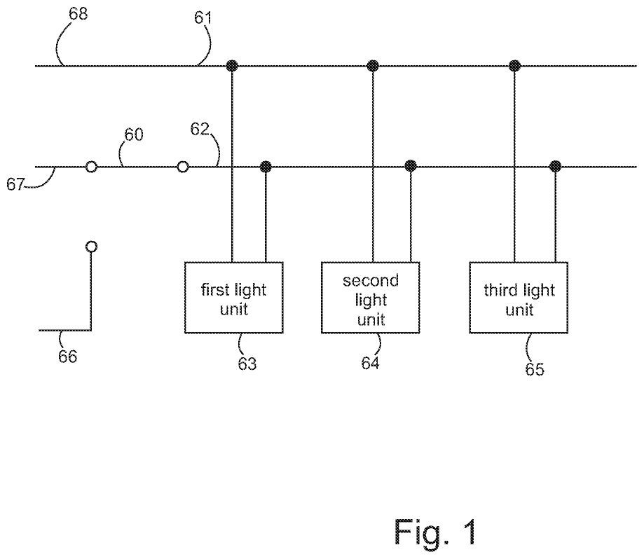

As seen in FIG. 1, a general diagram of the present invention has a neutral line 68 that pairs with a normal voltage line 67 and an emergency voltage line 66. The primary emergency switch 60 select between the normal voltage line 67, and the emergency voltage line 66. A number of light units such as first light unit 63, second light unit 64, and a third light unit 65 can be connected in parallel to the primary emergency switch. The first power input line 61 and the second power input line 62 respectively connect to the neutral line 68 and the hot line which is the normal voltage line 67 or the emergency voltage line 66. As seen in FIG. 1, the centralized emergency backup power system allows a first light unit 63, a second light unit 64 and a third light unit 65 to share a single emergency power source.

The primary emergency switch 60 can be fashioned as a relay, or any electrical switching device. During normal mode, normal voltage is controlled by wall switch to be on and off and emergency voltage is not available. When emergency voltage is available, it will trigger the switch to disconnect normal voltage and connect EM voltage. All lights will respond to EM voltage by turning off or working in emergency mode.

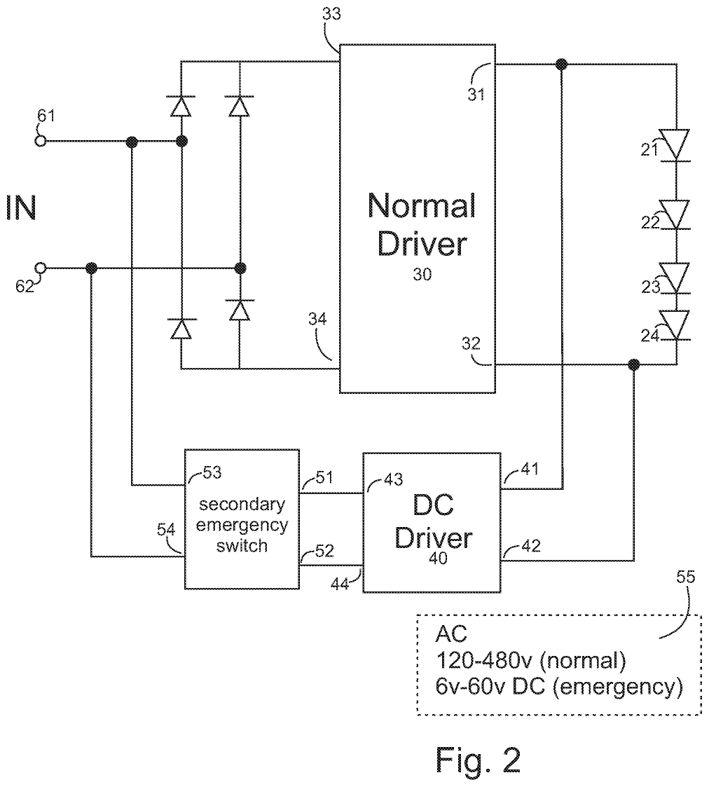

As seen in FIG. 2, a first lamp 21, a second lamp 22, a third lamp 23, and a fourth lamp 24 can be connected in parallel and driven by a normal driver 30 in a normal alternating current AC operation mode of 120-480V. The normal driver 30 has a normal driver first output 31, and a normal driver second output 32. The normal driver 30 also has a normal driver first output 31 and a normal driver second output 32. The normal driver output are normally connected to the series of lamps. The lamps can be LED chips or arrays of LED chips mounted in lighting fixtures.

When the normal voltage is switched to the emergency voltage line 66, the emergency voltage line 66 outputs a low-voltage emergency current having 6-60 volts in direct current (DC). The DC driver 40 has a DC driver first output 41 and a DC driver second output 42 connected in series with the lamps. The DC driver has a DC first input 43, and a DC driver second input 44. The secondary emergency switch 50 senses the change in voltage type from alternating current to direct current. The change of voltage type triggers the secondary emergency switch 50 to activate. The secondary emergency switch 50 is connected in parallel or series to the AC driver 30 and has a emergency switch first output 51 connecting to the DC driver first input 43 and a emergency switch second output 52 connecting to the DC driver second input 44. The secondary emergency switch 50 also includes an emergency switch first input 53 connected to the first power input 61 and an emergency switch second input 54 connected to the second power input 62. The secondary emergency switch 50 can be programmed or hardwired with a second emergency switch logic 55 for governing switching activation.

The normal driver can operate in a normal operation with the lamps in series. In an emergency situation, the secondary emergency switch can power a DC driver 40 which is connected in parallel to the normal driver 30.

In this type of configuration, the normal input voltage is AC, which could be from 100 VAC to 480 VAC. The emergency input voltage is DC. The logic circuit may have a rule driven logic with a lower emergency voltage than normal voltage. The lower emergency voltage may have partial light which would be a dimming effect. The emergency state may disable the normal driver 30 and enable the enable DC driver 40 to drive the LED array or a portion of the LED array.

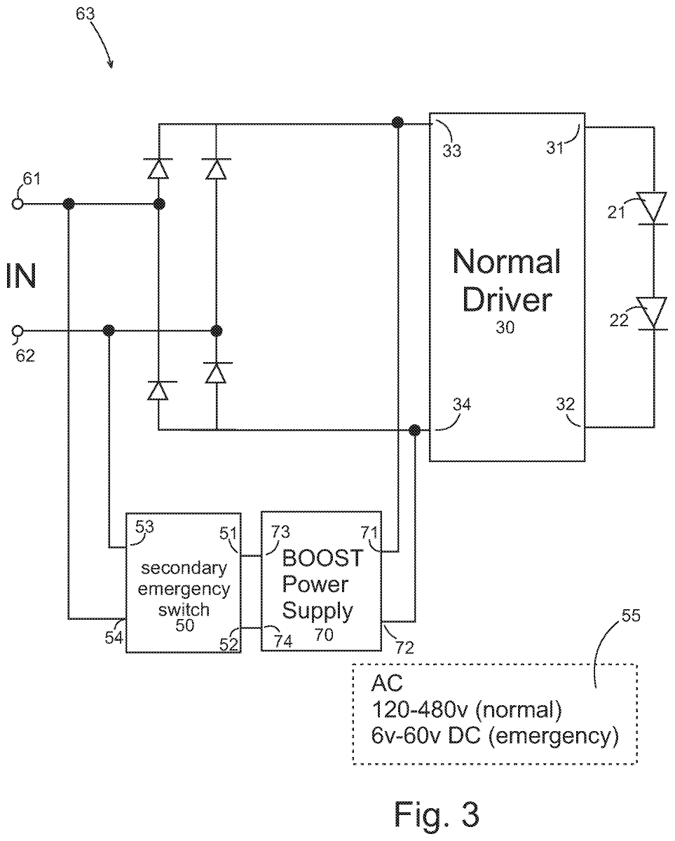

As seen in FIG. 3, a first lamp 21, and a second lamp 22 can be connected in parallel and driven by a normal driver 30 in a normal alternating current AC operation mode of 120-480V. The normal driver 30 has a normal driver first output 31, and a normal driver second output 32. The normal driver 30 also has a normal driver first output 31 and a normal driver second output 32. The normal driver output are normally connected to the series of lamps. The lamps can be LED chips or arrays of LED chips mounted in lighting fixtures.

The boost power supply 70 supplies an AC current from the BOOST power supply first output 71 and the BOOST power supply second output 72. The boost power supply 70 receives power from the secondary emergency switch 50 at the BOOST power supply first input 73 and the BOOST power supply second input 74. This configuration is more similar to a standard uninterrupted power supply UPS where DC power is converted back to AC power.

The DC driver 40 is connected in series to the driver. The secondary emergency switch logic 55 is built into the secondary emergency switch 50 and can switch to the boost power supply 70 when in emergency use. The secondary emergency switch 50 can be wired in parallel to the normal driver 30 because the normal driver 30 will not operate in an emergency condition.

The secondary emergency switch logic 55 may provide a normal alternating current voltage and a lower direct current voltage in an emergency state. The logic circuit can judge if the circuit is in an emergency mode. In an emergency mode, the logic circuit can boost the emergency voltage to keep the normal driver working at emergency level. For example, the emergency voltage can be set at a percentage of the normal light output, such as 10% of normal light output. The secondary emergency switch logic 55 may also disable any controls on the normal driver.

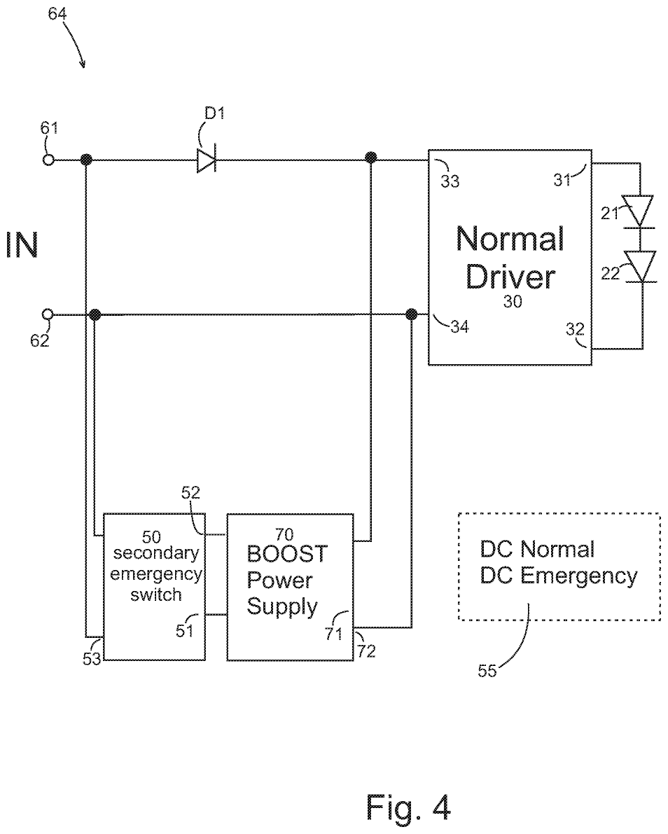

As seen in FIG. 4, a D1 first diode allows for a connection of the normal driver 30 in a DC mode. The lamps are DC lamps including a first lamp 21 and a second lamp 22 at a normal driver first output 31 and a normal driver second output 32. The normal driver first input 33 and normal driver second input 34 are both connected to the BOOST power supply 70. When the secondary emergency switch 50 senses a drop in voltage to an emergency level such as when the second emergency switch logic 55 is indicated for operation in emergency state, the secondary emergency switch 50 provides a first emergency switch first output 51.

The secondary emergency switch senses voltage on a secondary emergency switch first input 53 and compares the voltage with the secondary emergency switch logic 55 to determine if an emergency condition exists. The secondary emergency switch 50 is connected to the first power input line 61 and the second power input line 62. The BOOST power supply 70 has a BOOST power supply first output 71 and a BOOST power supply second output 72.

The second emergency switch 50, lamps 21 and normal driver 30 can be implemented as a second light unit 64 of the overall system. In this configuration, the nominal voltage is a high disease voltage and the emergency voltage is a low DC voltage. A Diode D1 prevents high voltage flowing back to low voltage. The logic circuit judges if the system is in emergency mode. If the system is in not in emergency mode, then the emergency voltage is boosted back to a normal voltage range. If the system is in emergency mode, then the logic circuit controls the driver to work at an emergency level.

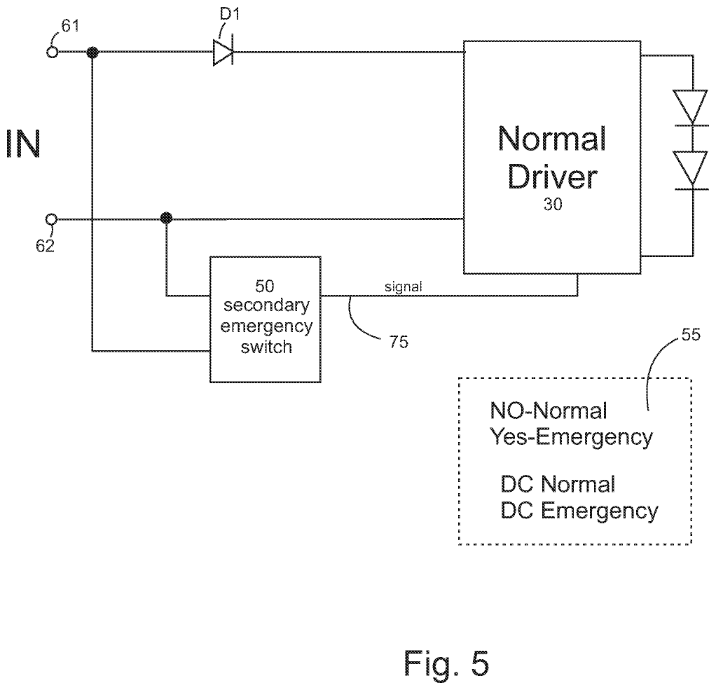

As seen in FIG. 5, the secondary emergency switch 50 uses a second emergency switch logic 55 and in the event of an emergency provides a emergency signal to the normal driver 30 through a signal connection 75 so that the normal driver 30 is configured to dim or otherwise control both the 61 first power input line and the 62 second power input line.

The normal voltage and input voltage are different, but the driver voltage range can cover both ranges. The logic circuit 55 judges if it is emergency mode. If in an emergency mode, the logic circuit 55 controls the driver to operate in the emergency mode and also disables any controls.

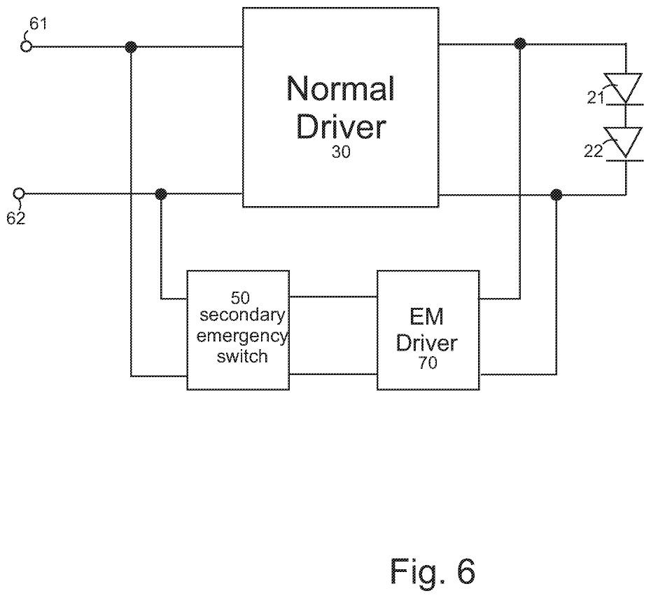

As seen in FIG. 6, the secondary driver and emergency driver are wired in parallel to the normal driver so that they replace the operation of the normal driver when the power condition changes from the normal state to the emergency state.

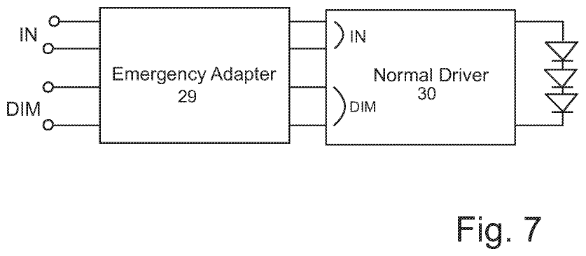

As seen in FIG. 7, an emergency adapter 29 can be connected to the normal driver 30 in a retrofit layout where the emergency adapter 29 has a power plug and dimming plug that can plug to the normal driver 30 input sockets and dimming sockets. In this way, the emergency adapter can be inserted in series to the normal driver 30. The emergency adapter 29 can output an emergency voltage and dimming signal that allows for an emergency mode of the normal driver 30 so that the normal driver 30 continues to operate even under the constraints of the emergency voltage and possible change between alternating current and direct current.

Again, the logic circuit senses if the present power state is in an emergency mode. If the power state is in an emergency mode, the logic circuit disables the normal driver, and enables the emergency driver to output at emergency levels for all or part of the LED lamps. This add-on goal power switching system can be formed as an emergency adapter which allows easy conversion of regular drivers to add an emergency function. When the emergency adapter logic circuit judges the power state to be in an emergency mode, the logic circuit disables the outside dim signal, buck or boost EM voltage to a normal voltage range and sends a dim signal to control the normal driver to drive the LED at an emergency level.

1. A dual power switching system comprising:
a. a power input;
b. a normal driver, wherein the power input is connected to the normal driver and powers the normal driver;
c. a logic circuit, wherein the logic circuit is configured to detect an abnormal power state;
d. a secondary driver, wherein the secondary driver is connected to the logic circuit, wherein the logic circuit activates the secondary driver in the abnormal power state; and
e. a series of lamps powered by the normal driver in a normal state, and powered by the secondary driver in the abnormal power state.

2. The dual power switching system of claim 1, wherein the lamps are connected to the normal driver and also the secondary driver.

3. The dual power switching system of claim 2, wherein the normal driver provides an AC output, but the emergency driver provides a DC output.

4. The dual power switching system of claim 2, wherein the normal driver provides a normal DC output, and the emergency driver provides a emergency DC output, wherein the emergency DC output is lower than the normal DC output.

5. The dual power switching system of claim 1, wherein the emergency power supply includes a secondary emergency switch and a boost power supply.

6. The dual power switching system of claim 5, wherein the normal driver provides an AC output, but the emergency driver provides a DC output.

7. The dual power switching system of claim 5, wherein the normal driver provides a normal DC output, and the emergency driver provides a emergency DC output, wherein the emergency DC output is lower than the normal DC output.

8. The dual power switching system of claim 1, wherein the emergency power supply is incorporated into the normal driver, wherein the normal driver has a secondary emergency switch.

9. The dual power switching system of claim 8, wherein the normal driver provides an AC output, but the emergency driver provides a DC output.

10. The dual power switching system of claim 8, wherein the normal driver provides a normal DC output, and the emergency driver provides a emergency DC output, wherein the emergency DC output is lower than the normal DC output.

11. The dual power switching system of claim 1, wherein the emergency power supply is incorporated as a DIM input into the normal driver, wherein the DIM input receives a signal from an emergency adapter, wherein the logic circuit is formed on the emergency adapter.

12. The dual power switching system of claim 1, wherein the normal driver provides an AC output, but the emergency driver provides a DC output.

13. The dual power switching system of claim 1, wherein the normal driver provides a normal DC output, and the emergency driver provides a emergency DC output, wherein the emergency DC output is lower than the normal DC output.
